(19) United States
(12) Patent Application Publication
(10) Pub. No.: US 2011/0240703 A1
(43) Pub. Date: Oct. 6, 2011

(54) HYDRATION SYSTEM

(76) Inventors: Marilene Hickmann Tobin, Tecumseh (CA); Russell John Tobin, Tecumseh (CA)

(21) Appl. No.: 13/133,963

(22) PCT Filed: Dec. 14, 2009
(86) PCT No.: PCT/US2009/067840

§ 371 Date: Jun. 10, 2011

Related U.S. Application Data
(60) Provisional application No. 61/193,667, filed on Dec. 15, 2008.

(51) Int. Cl. A45C 15/00; B67D 7/84

(52) U.S. Cl. 224/576; 222/175

(57) ABSTRACT

The present teachings provide hydration systems. Generally, the hydration systems include a storage area, a handle connected to the storage area, and a hydration apparatus contained in a region of the storage area. The hydration apparatus includes a hydration reservoir, a lid having at least one drink opening and a closure for the hydration reservoir, and a tube extending from the lid through the handle and towards the mouth of the user. The hydration system provides enhanced benefits of hydration in a discreet manner without requiring that the user sacrifice freedom or mobility.

### CROSS-REFERENCE TO RELATED APPLICATIONS

This application claims the benefit of U.S. Provisional Application No. 61/193,667 filed Dec. 15, 2008. The entire disclosure of the above application is incorporated herein by reference.

### FIELD

The present disclosure relates to a system for hydration, and more particularly to a bag including a hydration reservoir that can be used separately from the bag.

### BACKGROUND

This section provides background information related to the present disclosure which is not necessarily prior art.

Proper hydration is important for everyone. In addition, drinking fluids is an absolute necessity for some individuals. One example includes individuals who take medications that cause excessive dry mouth. Another example includes those who suffer from Xerostomia, a dry-mouth syndrome that is the consequence of not having enough saliva or any saliva at all in the mouth. Xerostomia can be a consequence of radiation treatment for oral cancer. Depending on the severity of the xerostomia, some individuals may be totally dependent on fluids at all times. Those who suffer with xerostomia must take a drink of water very frequently (even every fifteen seconds). The amount of fluid intake required depends on the type of exertion or the severity of the condition. This dependence on fluids can cause irritability, apprehension, anxiety, depression, and other symptoms because of the discomfort of the dry mouth. The constant interruption to take a drink is inconvenient and impacts basic activities such as talking, walking, shopping, eating, driving, and others. In addition to the distress, those with xerostomia must deal with the bothersome, inconvenient, and repetitive task of constantly drinking and “keeping up” with a beverage. Further, they also deal with stares and questions from others because of their abnormally high amount of fluid consumption in social or professional settings. The constant and mandatory intake of fluid is a troublesome task because it requires that the individual keeps track of the beverage and have at least one free hand to carry the beverage and a second hand to handle opening and closing the beverage.

An increased awareness of the need for proper hydration for everyone has led to the development of hydration solutions for home and outside use. Systems for home use, such as pitchers for holding purified tap water or water coolers are not easily portable for on-the-go use. Systems for outside use include water bottles or systems adapted for rigorous or athletic activity. Aside from disposable water bottles, some systems for outside use fix a water bottle to the wrist or palm of the user with a hand strap, while others fix the fluid in an athletic waist-pack or backpack. The latter systems are not versatile, are limited to use in only certain situations, and neglect the practical daily needs of users who are not participating in these activities. For example, the latter systems ignore those who want to maintain proper fluid intake or improve hydration during basic daily activities. This is particularly true for those who are dependent on fluid at all times due to their illness or medications.

For example, a mother shopping with small children will need to keep her hands free to shop and tend to the children, stroller, etc. She also does not want to carry anything extraneous aside from a purse or a diaper bag, if needed. In such a situation, the mother needs a system that is easily accessible, does not require that she carry an extra bag or grab a drink bottle and thereby occupy a hand. Also, she wants to maintain a level of fashion and does not desire an unattractive, athletic-looking system when participating in non-athletic daily activities. Similarly, many men also want discreetness and desire a sleek bag or pouch that is more sophisticated than a backpack. In certain situations, the athletic-looking device is not socially acceptable, particularly, in a professional or social setting.

Accordingly, discreet hydration systems and systems that are aesthetically pleasing and functional are needed.

### SUMMARY

This section provides a general summary of the disclosure, and is not a comprehensive disclosure of its full scope or all of its features.

In various embodiments, the present teachings provide hydration systems. Generally, the hydration systems include a storage area, a handle connected to the storage area, and a hydration apparatus contained in a region of the storage area. The hydration apparatus includes a hydration reservoir, a lid having at least one drink opening and a closure for the hydration reservoir, and a tube extending from the lid through the handle and towards the mouth of the user. The hydration system provides enhanced benefits of hydration in a discreet manner without requiring that the user sacrifice freedom, mobility, or style.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1B depict a woman and a man, respectively, having a hydration system placed on the shoulder according to aspects of the present teachings;

FIG. 2A depicts a partial cut-away view of the hydration system shown in FIG. 1A according to aspects of the present teachings;

FIG. 2B depicts a partial cut-away view of a multi-level hydration system according to aspects of the present teachings;

FIG. 2C depicts a partial cut-away view of a multi-level hydration system according to aspects of the present teachings;

FIGS. 3A-3D depict top views of the interior of the receptacle portion of the hydration system according to aspects of the present teachings;

FIGS. 4A-4B depict a flap closure in the receptacle portion of the hydration system according to aspects of the present teachings;

FIG. 5A-5C depict hydration reservoirs and lids according to aspects of the present teachings;

FIGS. 6A-6D depict lids according to aspects of the present teachings;

FIGS. 7A-7E depict fluid tubes according to aspects of the present teachings;

FIG. 8 depicts a hydration reservoir and lid according to aspects of the present teachings;

FIGS. 9A-9B depict a lid according to aspects of the present teachings; and

FIGS. 10A-10D depict the integration of fluid tubes into handles according to aspects of the present teachings.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

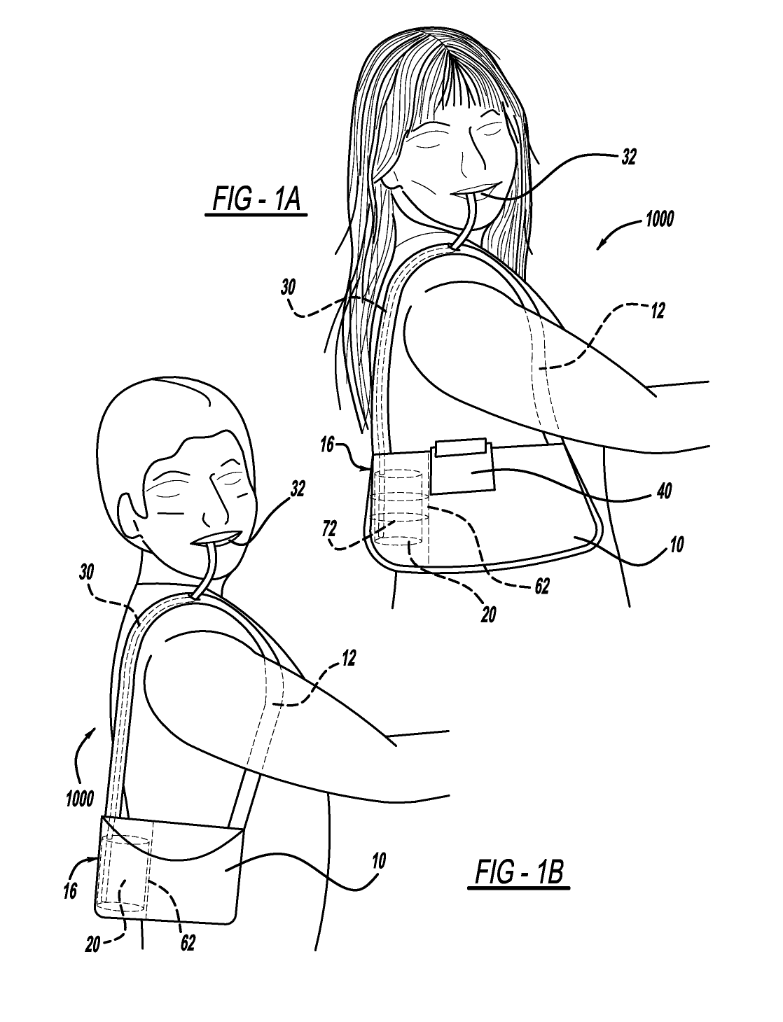

With reference to FIGS. 1A-10D, in various embodiments, the present teachings provide hydration systems 1000. Generally, the hydration systems 1000 include a storage area 10, a handle 12 (or strap) connected to the storage area 10, and a hydration apparatus 16 contained in a region of the storage area 10. The hydration apparatus 16 includes a hydration reservoir 20, a lid 22 having at least one drink opening and a closure 26 for the hydration reservoir 20, and a tube 30 extending from the lid 22 through the handle 12 and towards the mouth 32 of the user. The hydration system 1000 provides enhanced benefits of hydration in a discreet manner without requiring that the user sacrifice mobility. The user can drink while wearing the device by turning his or her head towards the handle 12, engaging a region of the tube 30 with their mouth, and conveniently sipping from the tube 30. The present teachings are applicable to new storage areas or to storage areas of existing bags, which can be retrofit with portions of the apparatus detailed herein to provide the systems of the present teachings.

Use of the hydration apparatus 16 outside of and separate from the storage area 10 and hydration system 1000 provides increased versatility for the present teachings. The user is not limited to a system in which the hydration source can only be used within the confines of its bag or sack-type container. As detailed later herein, the hydration apparatus 16 can be discreetly and quickly removed from the hydration system 1000 and then be placed on a table, counter, floor, chair seat, chair arm, car dash board, tray, as non-limiting examples, or another surface. This allows for on-the-go use including at social or professional settings. This is beneficial compared to systems in which a bladder is used because the bladder or water bag can neither be discreetly removed from its container nor can it be placed on a table or other surface in a social or professional setting without attracting unwanted attention. It is understood that the following description contains various features which may be interchanged between the various embodiments.

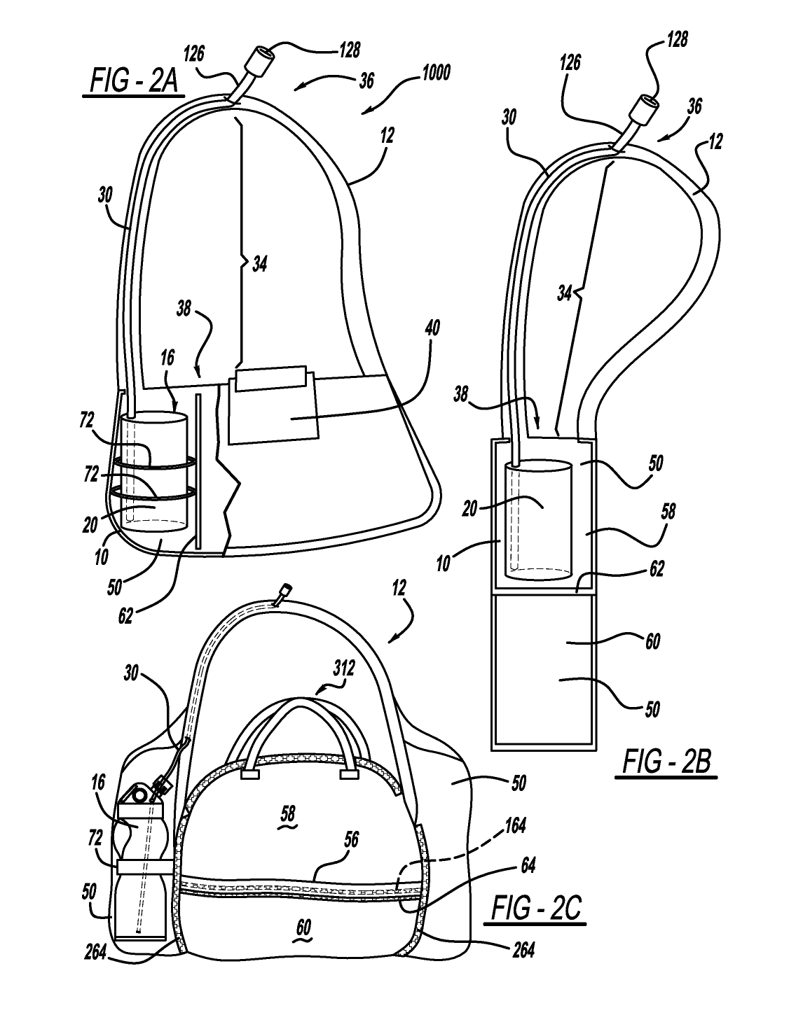

Referring to FIGS. 1A-2B, the storage area 10 can be shaped to hold various items. In various embodiments, the shape can be a purse, which is also known as a pocketbook or handbag, for women, and a man-bag or metro-bag, for men. Purses are a distinct category of bags defined by a drop 34 or distance from a summit 36 of the handle 12 to the opening 38 of the storage area 10. Generally, the opening 38 is adjacent to the handle 12 or is immediately adjacent to the handle 12 via a small connecting portion of material, normally to accommodate grasping the purse or facilitating closure of the purse, such as by zipping or by a fastener 40, such as a magnetic fastener as shown in FIGS. 1A and 2A. A purse differs from a backpack in that a purse is considered a fashion accessory (i.e. changed to match an outfit or shoes) while a backpack is more of a functional device (used for carrying books or equipment). A purse additionally differs from a backpack in that the backpack opening is on a surface opposite to the surface which the backpack straps are attached. Hence, a user of a backpack must take off the bag and turn it around to gain access to the contents of the backpack. To the contrary, the opening 38 of a purse generally faces upwards towards the underarm of the user so that the contents of a purse can be accessed with a single hand while the wearer is wearing the purse. For example, as shown in FIG. 1A, the wearer can easily bend and lift her elbow to place her hand in the opening 38 of the purse while the purse is on her shoulder.

To hold the purse, it is passed up a portion of the arm up to a desired location. For example, some purses are designed to be held at the wrist, others at the elbow, and still others are meant to be held on a single shoulder. Some users also hold a purse at a certain location based on personal preferences. Non-limiting examples of purse styles include hobo, satchel, wedding, barrel, bucket, shoulder, cross-body, various man-bags or metro-bags, and the like.

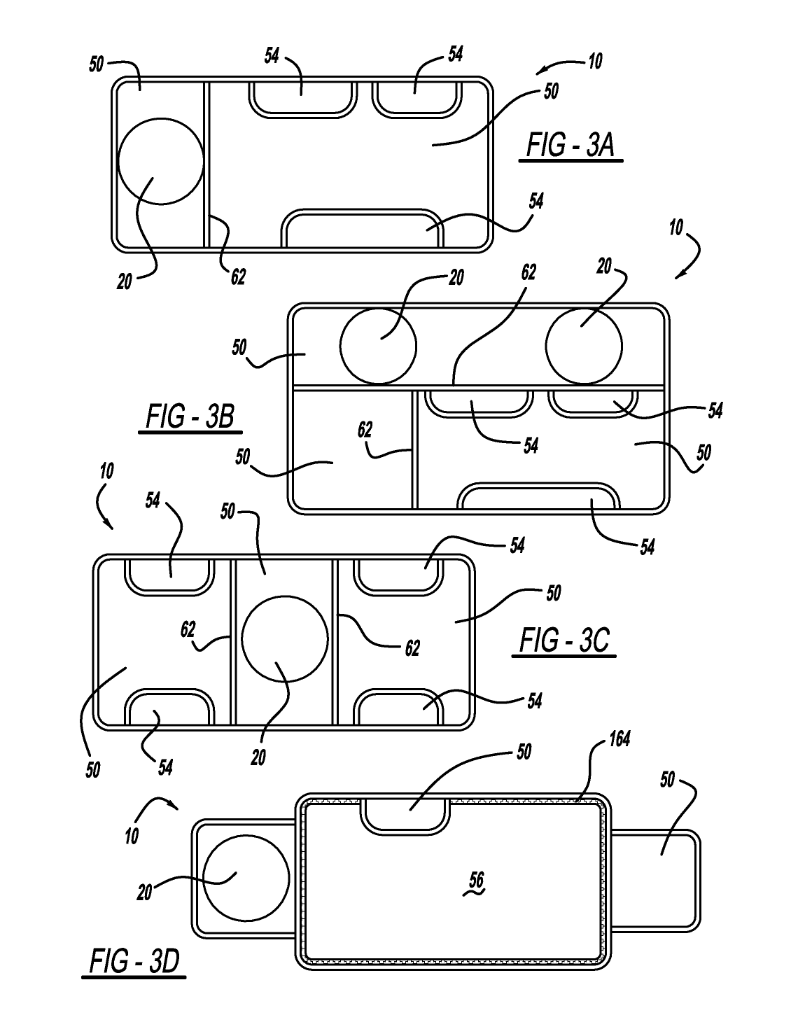

Turning to FIGS. 2A-3D, in various embodiments, the storage area 10 can define separate pouches 50 in which to hold items and at least one pouch 50 to hold a hydration reservoir 20, which is fully described later herein. The pouches 50 can be an integral part of the storage area 10 as shown in FIG. 3C, or they can be a smaller (or larger) side portion as shown in FIG. 3D and also FIG. 2C. The pouches 50 can also be detachable. For example, with reference to FIGS. 2C and 3D, the side pouch can include a zipper 264 (or buttons, snaps, magnetic closure, or the like) so that it can be zipped off or similarly removed from the storage area 10.

As shown in FIGS. 2B and 2C, the design of the device can be such that the pouches 50 can be stacked on top of each other to make a multi-level purse. This allows for easy access to the frequently accessed contents of the bag and also allows certain contents to remain separated until the user intentionally accesses them. Further, the multi-level purse allows the user to better utilize the whole volume of the bag instead of having all of the contents of the bag settle to the bottom, thereby causing the user to have to “dig around” to locate an item.

In such multi-level embodiments, the contents of a first level 58 would be segregated from the contents of a second level 60 by a floor 56. The first level 58 and the second level 60 can be used for different purposes, if desired. For example, the first level 58 could contain the hydration apparatus 16 and/or frequently used personal items, like keys, a cell phone, or a wallet, as non-limiting examples, and the second level 60 could contain another item or a lesser used item, like a personal hygiene item, sweater, brush, book, blanket, or scarf, as non-limiting examples.

In various embodiments, the floor 56 has sufficient strength to hold materials without allowing them to fall through to another level. The floor 56 can be made of the same material as the interior or exterior of the bag and be reinforced with a supporting or stiffening element to accommodate the weight of the contents of each layer, or the floor 56 can be made of different material. In still further embodiments, the floor 56 can be supported by additional reinforcing members (similar to posts or boning) located around the perimeter of the floor 56.

In various embodiments, the floor 56 can have a securing element (buttons, snaps, etc.) or zipper 164 to allow the user to reach down into a second level 60 of the bag from the interior of the bag. As shown in FIG. 2C, the second or lower level 60 includes two zippers (or buttons, snaps, etc.)—the external zipper 64 one to allow external access to the contents of the lower level 60 and an internal zipper 164 (phantom) to allow the contents of the lower level 60 to be reached from the interior of the bag. Further, the external zipper 64 can be used to completely detach the first level 58 from the second level 60 to provide a customizable shape and size of the bag.

The pouches 50 can be made of the same or a different material than the exterior storage area 10. In various embodiments, it can be a lining material, a decorative accent material, or it can be a material or substrate which has a functional purpose. For example, the storage area 10 can include a barrier layer 62 to keep the hydration apparatus 16 separate from other regions of the storage area 10. With specific reference to FIG. 2B, the barrier layer can be used to separate the first level 58 from the second level 60. In other embodiments, the barrier 62 can be a water-resistant area to protect the entire device from spillage or staining. Optionally, the barrier 62 can be an insulating layer to keep the contents of the hydration apparatus 16 or other contents of the storage area 10 cold or warm. It is understood that a single separator layer can employ one or several of the above-identified features. For example, in various embodiments, a hydration system 1000 can include one, two, or more layer(s) having both water-resistant and insulating properties.

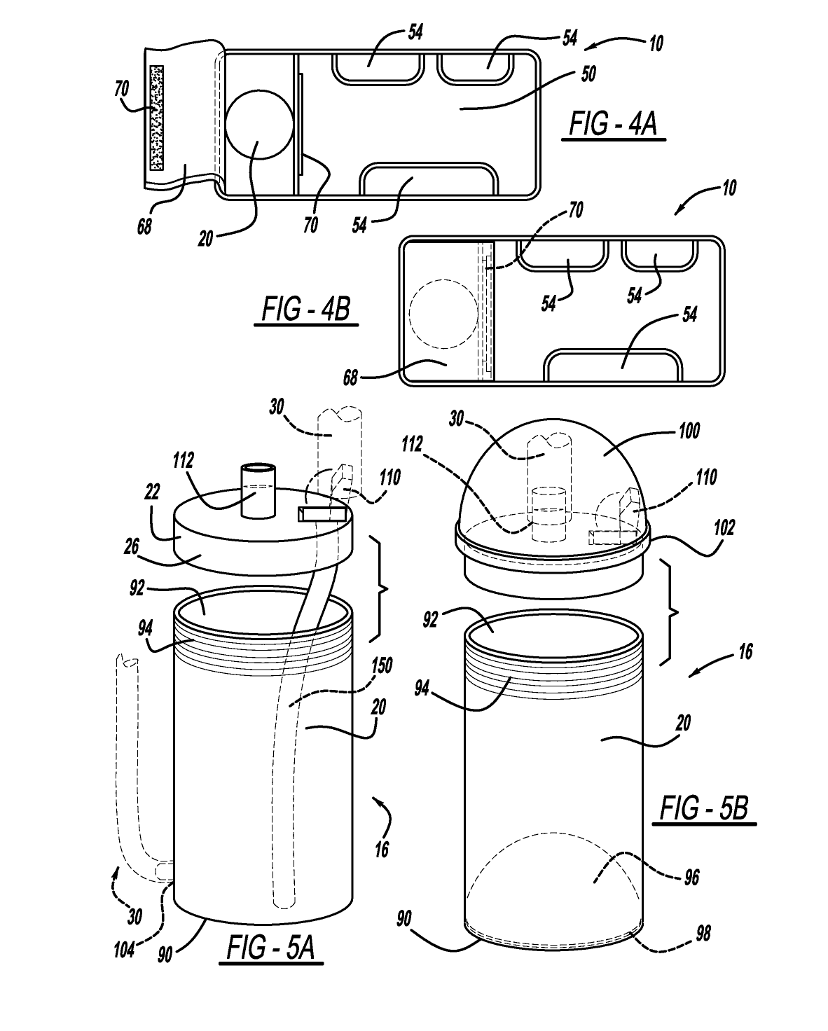

The hydration apparatus 16 is removably fixed within a region of the storage area 10. The hydration apparatus 16 can be held in place by a flap 68 of material or fabric such as is shown in FIGS. 4A and 4B. After the hydration apparatus 16 is placed within the pouch 50, the flap 68 can be aligned over the hydration apparatus 16 and optionally secured using a removable fixation, such as the hook-and-loop securing means 70, as shown in FIGS. 4A and 4B or by a snap, a zipper, magnetic closure, buttons, or the like. In various embodiments, the flap includes water-proof or water-resistant features to protect the contents of the pouch 50.

In various embodiments, the hydration apparatus 16 can be secured using bands 72 secured to an interior of the storage area 10 as shown in FIGS. 1A and 2A. This allows the user to quickly remove and replace the hydration apparatus 16 within the storage area 10. In various embodiments, the bands 72 can be made of a stretchy material to snugly secure the hydration apparatus 16 within the storage area 10.

As depicted in FIGS. 3A-3D, the hydration reservoir 20 can be located at different areas within the storage area 10. As shown in FIG. 3A, there is a pouch 50 with a series of pockets 54 and a pouch 50 along the side containing the hydration reservoir 20. The present teachings also include hydration systems 1000 in which there is more than one hydration reservoir 20 in the pouch 50 such as the device shown in FIG. 3B. While FIG. 3B depicts only two hydration reservoirs 20, it is understood that more than two hydration reservoirs 20 can be placed within a single hydration system 1000. Further, as shown in FIG. 3B, the hydration reservoirs 20 are placed along a back side of the storage area 10, or in other words, the portion that would directly engage the torso of the wearer. For example, as shown in FIG. 3C, the hydration reservoir 20 is in the center pouch 50. It is understood that any combination of hydration reservoir 20 number or placement within the storage area 10 is within the scope of the present teachings.

With reference to FIGS. 1A-1B and 10A-10D, the handle 12 is connected to the storage area 10 to allow the user to carry the hydration system 1000. The handle 12 is adapted to fit over the arm or shoulder of a wearer, as shown in FIGS. 1A and 1B. In various embodiments, the handle 12 allows the storage area 10 to be secured underneath the arm of the user. The handle 12 can include features to adjust the length of the handle 12 to accommodate the needs of the user. The handle 12 can also be detachable from the storage area 10 to change the style of the hydration system 1000 or to use with a selected level of the multi-level systems detailed above.

With reference to FIGS. 10A-10D, the handle 12 defines a summit 36 or top region in which an exit or opening 80 is defined to allow passage of the tube 30. The tube 30 can pass in a sleeve 88 formed in the handle 12. The sleeve 88 can extend for a region of the handle 12 or extend along the entire length of the handle 12. The sleeve 88 can be used to pass the tube 30 to the opening 80. The sleeve 88 can also have a supplementary use, such as to pass earbuds or earphones to the head of the user, as a non-limiting example. In various embodiments, the sleeve 88 can be accessed by the zipper 64 or other securing means used to keep the tube 30 within the handle 12. The tube 30 can also be discreetly aligned along an exterior of the handle 12.

In various embodiments, the exit or opening 80 can be in the form of a bore or a slit. With reference to FIG. 10C, in still other embodiments, the exit can be partially formed by a separate or secondary material such as a grommet 82, as a non-limiting example. The exit can also be in the form of a flap in which the user can easily tuck the proximal end 122 of the tube 30 within the handle 12 and hide it entirely within the handle 12 by closing or securing the flap either by using snaps 86 shown in FIG. 10B, folding the flap over itself, using hook and loop 70 fasteners, and the like. The handle 12 can also include an auxiliary handle 312 or handles which are not connected to the tube 30, as shown in FIG. 2C. Returning to FIGS. 10A-10D, by having the tube 30 exit the handle 12 at a summit 36, the exposure of the tube 30 is minimized to prevent its interference with the activities of the user or the appearance of the user.

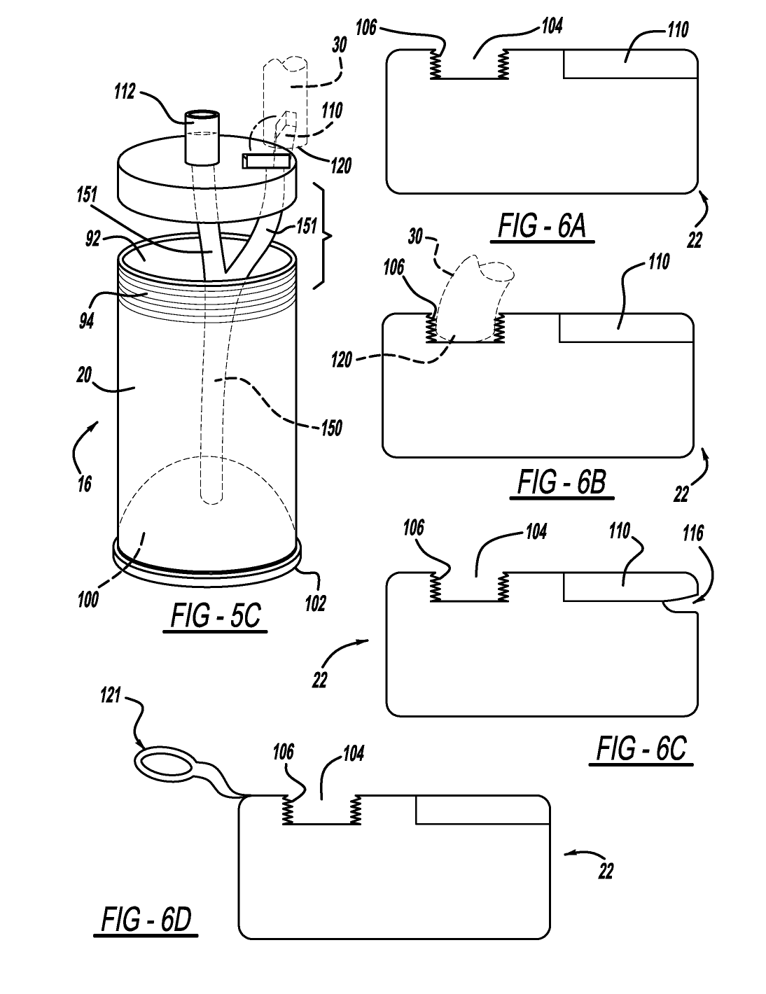

Turning to FIGS. 5A-6D, the hydration apparatus 16 generally includes a hydration reservoir 20 and a lid 22. The hydration reservoir 20 defines the region to contain a fluid or even a solid or semi-solid substance. The hydration reservoir 20 includes a bottom tip-resistant surface 90 and an upper mouth region 92. The upper mouth region 92 is mated with the lid 22 to provide closure and prevent the contents of the reservoir from inadvertently spilling. In various embodiments, the hydration reservoir 20 includes threads 94 on the upper mouth as shown in FIG. 5C. It is understood that the threads 94 can be placed on either of the lid 22 or the upper mouth either on an exterior surface thereof or an interior surface thereof and still be within the scope of the present teachings.

As shown in FIG. 5A, the bottom surface 90 of the hydration reservoir 20 is of a shape such that it can stand independently while placed on a table, floor, counter, desk, chair arm, car dashboard, etc., or other surface outside of the storage area 10. In other words, the bottom surface 90 of the hydration reservoir 20 can be flat, include flat surfaces at select regions, or can have another shape that is balanced against the weight of the hydration apparatus 16 such that contents of the hydration reservoir 20 do not spill or tip over inadvertently. For example, it is known that some novelty drinking devices include rounded, angled, or curvilinear bottoms which initially appear as though they will tip over but will not tip after the drinking device self-balances.

With reference to FIGS. 5B and 5C, in various embodiments, the bottom surface 90 of the hydration reservoir 20 can include a recess 96 to accommodate a top 100 which fits over the lid 22. As a non-limiting example, the top 100 is depicted as a dome in FIGS. 5B and 5C. The top 100 can be made of the same or different materials as the hydration reservoir 20. In various embodiments, the top 100 can include a mirrored interior and/or exterior surface so that the user can check their appearance.

The top 100 includes a housing area which defines a void to cover the lid 22. The top 100 also includes a lip 102 which is used to removably secure the top 100 onto the lid 22. As shown in FIG. 5B, the recess 96 accommodates the top 100. The recess 96 is depicted as a negative of the shape of the top 100. The lip 102 of the top 100 can be used to secure the top 100 into the negative recess 96. The lip 102 can also be used, similar to a coaster and prevent marring of the surface upon which the hydration reservoir 20 is placed. It is understood that the top 100 need not be in the shape of a dome. It is also understood that while the top 100 is shown being partially secured within the recess 96, that all of the top 100 (including the lip 102) can be secured within the bottom 90 of the hydration apparatus 16 within the scope of the present teachings.

The lid 22 via closure 26 provides closure to the contents of the hydration reservoir 20, facilitates connection of the tubing to the hydration reservoir 20, and also facilitates consumption of the contents of the hydration reservoir 20 by various methods. For example, the user can consume the contents of the hydration reservoir 20 using it as a “wide mouth” device where the lid 22 is completely removed. This “wide mouth” can be standard industry size (for example, the 3.5″ diameter size for certain bottles) for use with other bottles, or it can be a customizable size. The ability to consume the contents of the hydration reservoir 20 in different manners is useful when the hydration reservoir 20 is used separately from the storage area 10, as detailed above. Alternatively, the user can use any of the at least one additional drink openings. The drink openings can be flush with the top of the lid 22, as shown in FIG. 6A, or the drink openings can be proud to the lid 22, as shown in FIG. 5C. Further, an access port 104 can be recessed in the lid 22 as shown in FIGS. 6A-6D. As shown the access port 104 contains surface features 106 to facilitate gripping the tube 30 to assemble the hydration system 1000. It is understood that the surface features 106, such as threads or ridges, are optional and the tube 30 can fit on the access port 104, the flip-spout 110, or the stand-up spout 112 via an interference fit.

With reference to FIG. 5A, in various embodiments, the access port 104 can be placed anywhere on the lid or along the hydration reservoir 20. In the latter embodiment, the tube 30 can be connected to the access port 104 to access the contents of the hydration reservoir 20. Although FIG. 5A illustrates that the access port 104 is at the bottom of the hydration reservoir 20, it is understood that the placement can be anywhere along the exterior of the hydration reservoir 20, proud to the surface of the hydration reservoir 20, or recessed into the hydration reservoir 20.

As shown in FIGS. 5A-5C and 6A-6D, the drink openings can include a flip spout 110, and a stationary spout 112 and combinations thereof, as non-limiting examples. It is understood that other drink openings are also within the scope of the present teachings, although they are not depicted. For example, a push-pull or twist top are also non-limiting and exemplary tops that are suitable with the present teachings.

As shown in FIGS. 5A-5C, the flip spout 110 can be moved through a range of motion as depicted in the phantom lines. The flip-spout 110 can be used to connect the tube 30 to the hydration reservoir 20, as shown in FIG. 5A. The flip spout 110 can be accessed or actuated with a thumb or finger of the user. In various embodiments, the lid 22 can include an optional notch 116 or recess to accommodate a thumb or finger of the user. The combination of drink openings allows for sipping, gulping, and sucking out contents of the hydration reservoir 20. The variety of options increases the versatility of the hydration system 1000 and use of the hydration reservoir 20 and/or the lid 22 separate from the hydration system 1000.

With reference to FIGS. 5A and 5C, a straw 150 or other mechanism can provide access to the hydration reservoir 20 contents and facilitate consumption of the contents of the hydration reservoir 20. As shown in FIG. 5A, the straw 150 is connected to the flip-spout 110 to facilitate consumption of the contents of the hydration reservoir 20. As shown in FIG. 5C, the straw 150 is bifurcated and has arms 151 so that the contents of the hydration reservoir 20 can be accessed through the stand-up spout 112 or the flip-spout 110. The straw 150 can include more than two arms (such as three-, four-, or five-arm straw) and any number of the arms on the straw can be selectively attached to a few or all of the drink openings or access ports, respectively. It is understood that the straw 150 can be a separate item. It is also understood that the tube 30 can be advanced downwards into the hydration reservoir 20 and serve as a “straw” to access the contents of the hydration reservoir 20. The straw 150 and/or the tube 30 can also be flavored to impart a particular taste (such as fruit, mint, herbal, etc.) to the water.

In various embodiments, the lid 22 or the hydration reservoir 20 can also include a holder or a ring 121 to hold the bottle or the lid 22, as illustrated in FIG. 6D. The ring 121 can be permanently attached or it can be detachable from the lid 22 or the hydration reservoir 20. The ring 121 can be in the shape depicted in FIG. 6D or it can comprise a shape suitable for attachment to another device, such as a carabiner. As will be detailed later herein, the lid 22 also includes a connection region at which the tube 30 is attached.

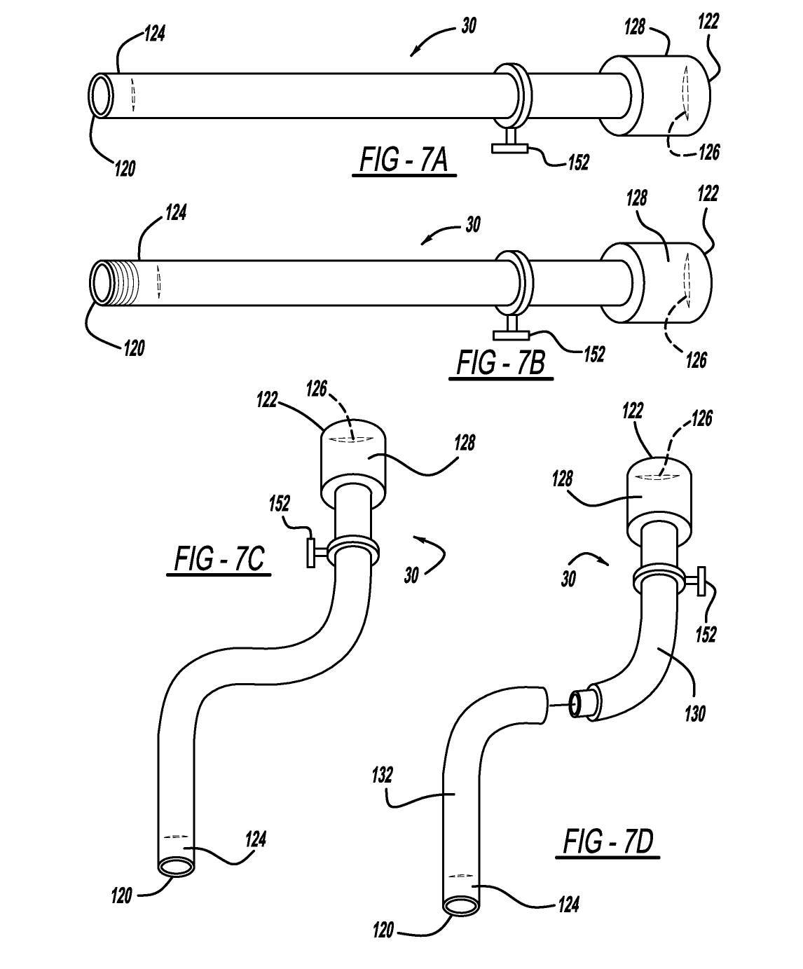

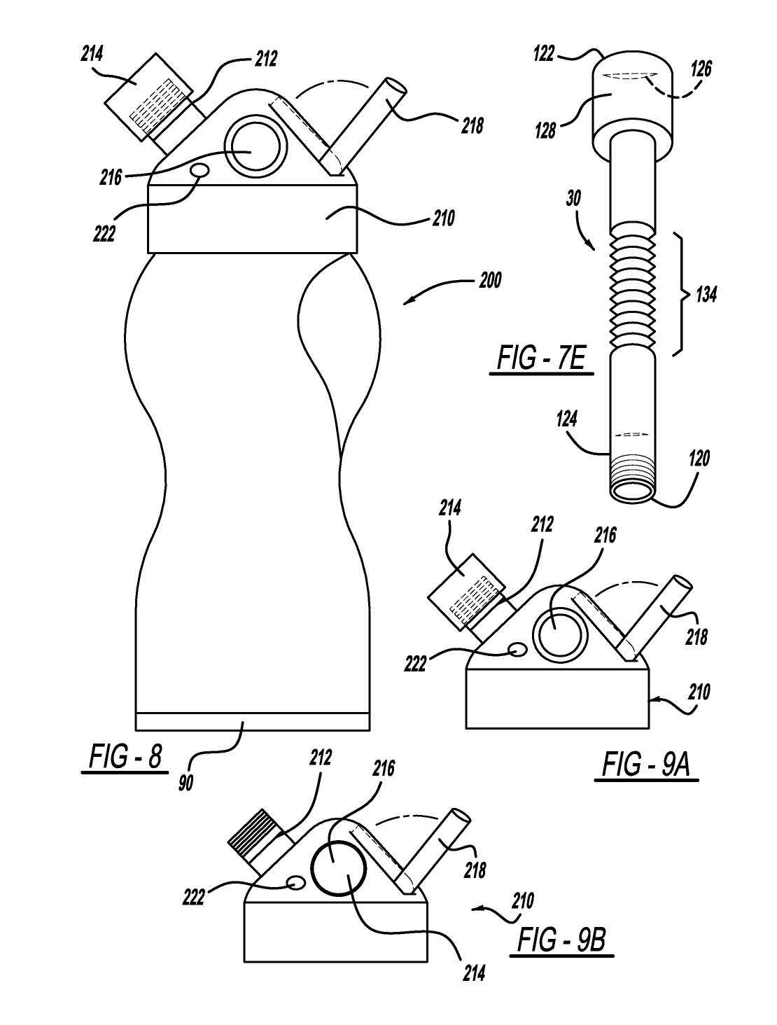

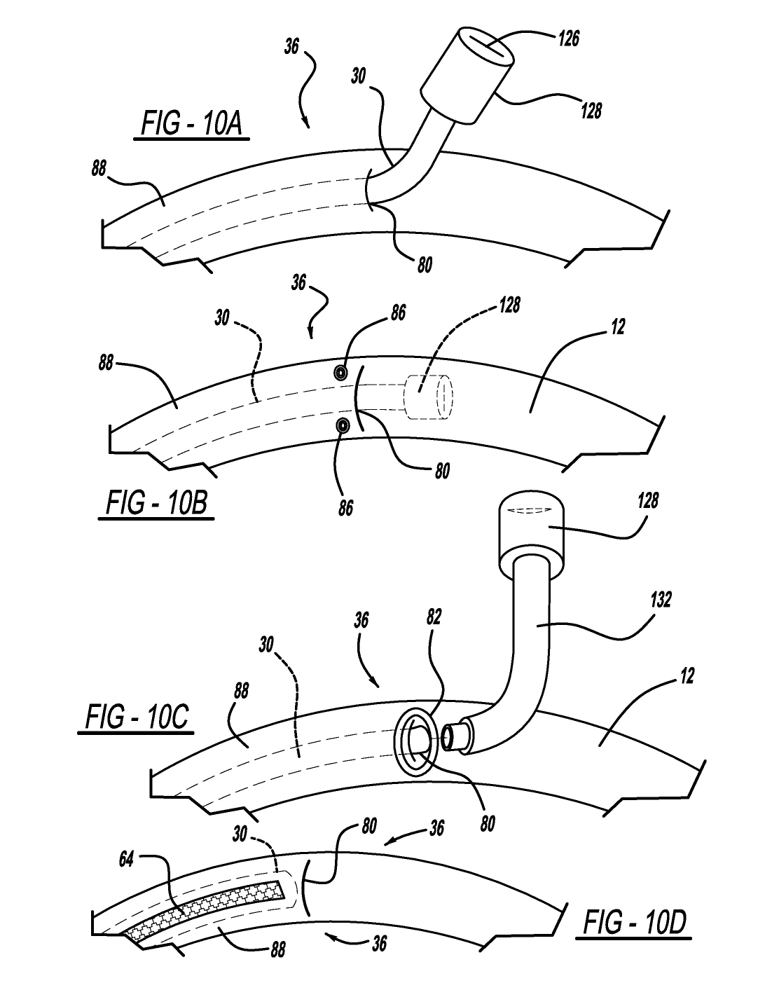

Turning to FIGS. 1A-1B and 7A-7E, the tube 30 is used to connect the hydration reservoir 20 or lid 22 to the handle 12 to allow the user to consume the contents of the hydration reservoir 20. The tube 30 can have a circular diameter that is maintained due to the rigidity of the materials, or it can be flat and expands when the fluid passes through the tube 30. In various embodiments, a flattened tube may provide enhanced comfort along the handle 12.

The tube 30 includes a distal end 120 and a proximal end 122. The distal end 120 is connected to a region of the lid 22 such as the access port 104, as indicated by the phantom lines in FIG. 6B, the stand-up spout 112, as indicated by the phantom lines in FIG. 5C, the flip-spout as illustrated in FIG. 5A, or a region of the hydration reservoir 20 as illustrated in FIG. 5A. The distal end 120 can be pushed into a recess of the lid 22 or onto (or into) a proud spout of the lid 22. The distal end 120 includes a distal valve 124 to prevent the contents of the tube 30 from spilling. For example, if the user were to remove the tube 30 from the lid 22, if there were any trapped fluid in the tube 30, the distal valve 124 would reduce and/or prevent leakage from the tube 30. The valve can be actuated by hand pressure, mouth pressure or sucking, or the valve can have a stop action, such as a ball mechanism or any other valve systems.

Although not shown, the tube 30 can include a quick-connect feature, such as those well-known in the art, to connect it to the hydration reservoir 20 or lid 22. In various embodiments, the tube 30 can include a shut-off valve 152 to allow or stop flow of the contents of the tube 30. The shut-off valve 152 can be placed at the proximal end 122 and/or the distal end 120 of the tube 30.

The tube proximal end 122 is where the user engages the tube 30 with their mouth 32 to obtain the contents of the hydration reservoir 20. The proximal end 122 includes a proximal valve 126 to allow the user to control the release of the contents of the hydration reservoir 20 into their mouth 32. The proximal valve 126 can optionally be in the form of a bite valve 128 or any other mouth dispensing piece which functions to allow a user to control the flow of a fluid into their mouth 32. The bite valve 128 can be integral with the tube 30 or it can be a separate accessory that the user adds at a later point. This allows for customization of the hydration apparatus 16.

The size of the distal valve 124 and the proximal valve 126 can be separately modified to fit within the dimensions of the handle 12 and a surrounding region of the storage area 10 that is attached to the handle 12. For example, both the distal valve 124 and the proximal valve 126 can be sized to easily slide within the sleeve 88 of the handle 12. In other embodiments, the distal valve 124 can be sized to accommodate the connection at the lid 22. In still other embodiments, the proximal valve 126 can be sized to accommodate the size of the handle 12 or the bite needs of the particular wearer.

The tube 30, the hydration reservoir 20, the lid 22, and the valves can be formed of any material that is safe to contact a food or beverage source. The materials can be washable, include an antimicrobial coating or substance, can be permanent, or can be single-use or disposable. Example materials include polymers, such as polycarbonate, PTFE, glass, stainless steel, and the like. The tube 30 and the valves can be flexible, semi-rigid, or rigid. The tube 30 can also be made of a material that contains an anti-microbial to prevent the growth of microbes in the system. The tube 30 material can optionally be washable, so that the user can remove the tube 30 from the bag and clean it.

As shown in FIGS. 7D and 10C, the tube 30 can be formed of two separate pieces 130 and 132. The pieces can be made of the same or different material. The pieces can also be permanent or limited-use (such as single use or a time period use, such as a weekly or monthly use, for example). The tube 30 can be pre-curved to match the contour of the handle 12 or the needs of the dispensing region, as shown in FIGS. 7C and 7D.

As shown in FIG. 7E, the tube 30 can also include a region that is dissimilar from the other regions of the tube 30. This can be a different material or a different feature or contour of the same or a different material. For example, the tube 30 of FIG. 7E includes an expansion region 134 or an accordion-style portion that can be used to flex the tube 30 or can be used to lengthen or shorten the tube 30. The expansion region 134 can be made of the same or different material as the remainder of the tube 30. For example, the expansion region 134 could be made of a more rigid material that had increased shape-retention so that when the expansion region 134 is expanded or compressed, it remains in that shape until the user intentionally compresses or expands the region again. In other embodiments, the expansion region 134 can be made of a more flexible material than the rest of the tube 30 to allow the user to easily flex and contour a rigid tube via the expansion region 134.

Turning to FIGS. 8-9B, in various embodiments, the present teachings provide a hydration reservoir 200 and lid 210. The features of the hydration reservoir 200, particularly the ability to be used with a top 100 and top lip 102, bottom recess 96, bottom groove 98, and stand-alone features are the same as with hydration reservoir 20. With respect to the lid 210, the connection mechanism with the tube 30 via an access port 222 are the same as those detailed above for the lid 22. Further, the hydration reservoir 200 is integrated into and can be removed from the storage area 10 as detailed above with respect to the hydration reservoir 20.

As shown in FIG. 8, the hydration reservoir 200 has a contoured shape. The contour can provide ergonomic features, or the contour can be specialized to facilitate a specialized fit within a pouch 50 of the storage area 10.

The lid 210 includes at least one drink opening. As shown in FIGS. 9A and 9B, the drink openings include a pour spout 212 to accommodate a cap 214, a cap holder 216, a flip spout 218, and an access port 222 for the tube 30 which is used in the manner described above. The cap 214 can be pushed or threaded onto the pour spout 212. When the cap 214 is removed from the pour spout 212 to allow the user to drink, the user can temporarily store the cap 214 in the cap holder 216 as shown in FIG. 9B. The cap holder 216 defines a recess or indentation in which the user can secure the cap 214 by an interference fit or by any other means without having the cap 214 become dislodged. This allows the user to drink from the pour spout 212 without having to worry about losing the cap 214 or setting it on a dirty or otherwise undesirable surface.

In various embodiments, the lid 210 forms a partially raised pyramid although any shape is suitable for the lid 210. It is understood that the lid 210 can be a true pyramid or it can have any combination of sharp angled and curved faces that would generally mimic the shape of a pyramid. For example, one shape could be that two faces of the pyramid are generally flat or angled while the other two faces of the pyramid are rounded and have a slightly concave or convex arcuate shape. In various embodiments, the flip spout 218 and the pour spout 212 are placed on opposing surfaces of the lid 210 (or opposite faces of the pyramid). This allows the user to quickly turn the system around and consume the fluid from either of the drink openings. It is further understood that the majority of the lid 210 can be substantially flat or it can have a slight concave or convex shape.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A hydration system comprising:
a. at least one storage area;
b. a handle on the storage area; and
c. a hydration apparatus contained in a region of storage area,
the hydration apparatus comprising:
i. a hydration reservoir;
ii. a lid providing at least one drink opening and a closure for the hydration reservoir; and
iii. a tube extending from the lid through an opening in the handle.

2. The hydration system of claim 1, wherein the storage area defines at least two separate pouches.

3. The hydration system of claim 1, wherein the hydration apparatus is removably fixed in the storage area.

4. The hydration system of claim 1, wherein the hydration apparatus is adapted for use separate from the hydration system.

5. The hydration system of claim 1, wherein the hydration reservoir includes a tip-resistant bottom surface.

6. The hydration system of claim 1, further comprising a cover for the lid which is adapted to fit in a recess on a bottom surface of the hydration reservoir.

7. The hydration system of claim 1, wherein the storage area includes at least two levels where at least one level is separated from another level by a removable floor.

8. The hydration system of claim 1, wherein the tubing further comprises a dispensing valve and the valve is sized to be received entirely within the handle.

9. The hydration system of claim 1, wherein at least a region of the storage area includes a feature selected from the group consisting of: a barrier layer, a water proof layer, or an insulating layer.

10. A hydration system comprising:
a. a purse contoured to fit under the arm of a user, the purse having a handle and a storage area;
b. a hydration apparatus contained in a region of the purse, the hydration apparatus comprising:
i. a hydration reservoir having a tip-resistant bottom surface;
ii. a lid providing at least two drink openings and a closure for the hydration reservoir; and
iii. a tube extending from the lid through the handle.

11. The hydration system of claim 10, wherein the purse further defines a flap to removably cover the hydration reservoir.

12. The hydration system of claim 10, wherein the hydration apparatus is separated within the storage area by a barrier.

13. The hydration system of claim 10, wherein the purse contains only a single handle adapted to fit over a shoulder of a wearer and the tube exits from the handle at a summit of the handle.

14. The hydration system of claim 10, wherein the handle includes a grommet through which the tube extends.

15. The hydration system of claim 10 further comprising an auxiliary handle.

16. The hydration system of claim 10 wherein the tube comprises a permanent region fixed within the handle and a removable region for drinking.

17. A hydration apparatus comprising:
a. a hydration reservoir; and
b. a lid providing at least two drink openings, a receptacle, and a closure for the hydration reservoir.

18. The hydration apparatus of claim 17, wherein the hydration apparatus is connected to a dispensing tube which passes through a handle connected to a storage area.

19. The hydration apparatus of claim 17, wherein one of the at least two drink openings comprises a spout having a cap.

20. The hydration apparatus of claim 19, wherein the cap fits within the receptacle of the lid to removably secure the cap.
